(19) United States
(12) Patent Application Publication
(10) Pub. No.: US 2009/0037817 A1
(43) Pub. Date: Feb. 5, 2009

(54) SOURCE AND PREVIEW PANES FOR MEDIA CONTENT

(76) Inventors: Christopher Lee Bennetts, Hsin Tien City (TW); Christopher W. Larsen, Houston, TX (US); Nozomu Yasui, Taipei (TW)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/830,279

(22) Filed: Jul. 30, 2007

(51) Int. Cl. G06F 3/048

(52) U.S. Cl. 715/716; 715/781

(57) ABSTRACT

A system comprises a display and logic coupled to the display. The logic causes a source pane and a preview pane to be shown on the display. The source pane identifies sources of media content to be viewed in the preview pane. The preview pane plays for a user a selected media content while the source pane is still viewable.

### BACKGROUND

It is possible for a user of a computer to select on-line media content to be downloaded and played on the user's computer. An increasing array of media content choices are available to users. Managing the array of choices in a user-friendly and intuitive manner is a concern.

### BRIEF DESCRIPTION OF THE DRAWINGS

For a detailed description of exemplary embodiments of the invention, reference will now be made to the accompanying drawings in which:

FIG. 1 shows a system in accordance with embodiments of the invention;

FIG. 2 shows an embodiment of a computer usable in the system of FIG. 1;

FIG. 3 shows an example of metadata usable by the system of FIG. 1;

FIG. 4 shows a method in accordance with embodiments of the invention; and

FIGS. 5-7 illustrates the operation of a content playback tool in accordance with embodiments of the invention.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection. The term “system” refers to a combination of two or more components. A system may comprise, for example, a computer, a combination of computers, or a subsystem within a computer.

### DETAILED DESCRIPTION

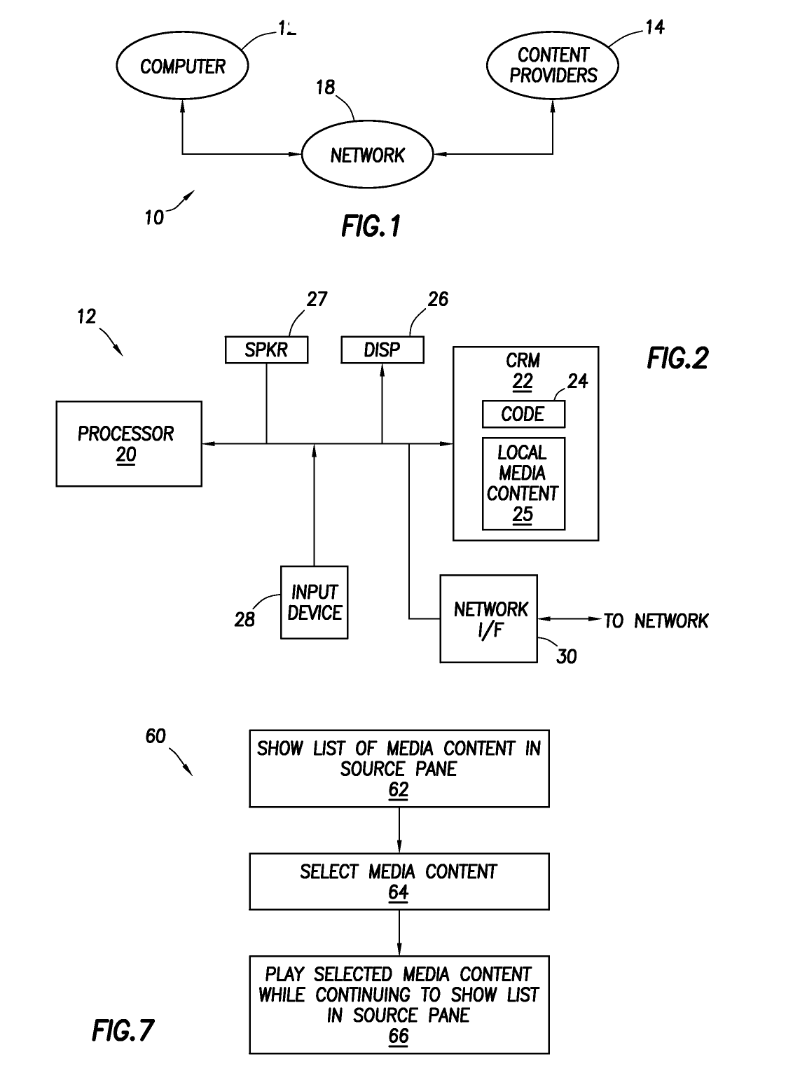

FIG. 1 shows a system 10 in accordance with various embodiments. As shown, system 10 comprises a computer 12 communicatively coupled to one or more content providers 14 via a network 18. In various embodiments, the network 18 comprises a local area network (LAN), a wide area network (WAN) or any other suitable network. In some embodiments, network 18 comprises the internet. The computer 12 comprises a device that can play media content provided, for example, by one or more of the content providers 14.

In various embodiments, the media content comprises video, audio, or combinations of video and audio. In some embodiments the media content comprises video-on-demand (VOD), a streamcast (i.e., a data stream that is available for receiving at a scheduled time), or other types of media content. Media content may comprise “local” or “remote” media content. “Local” media content refers to media content stored on the same computer (e.g., computer 12) that is used to play back such media content. “Remote” media content comprises media content stored at a location that is accessible to the playback computer (e.g., computer 12) via a network (e.g., network 18). Local media content may have been downloaded over the network 25 and then stored on computer 12 for subsequent playback thereon, or may have been provided to the computer 12 via other sources (e.g., compact disc read-only memory (CDROM), portable Flash memory device, etc.).

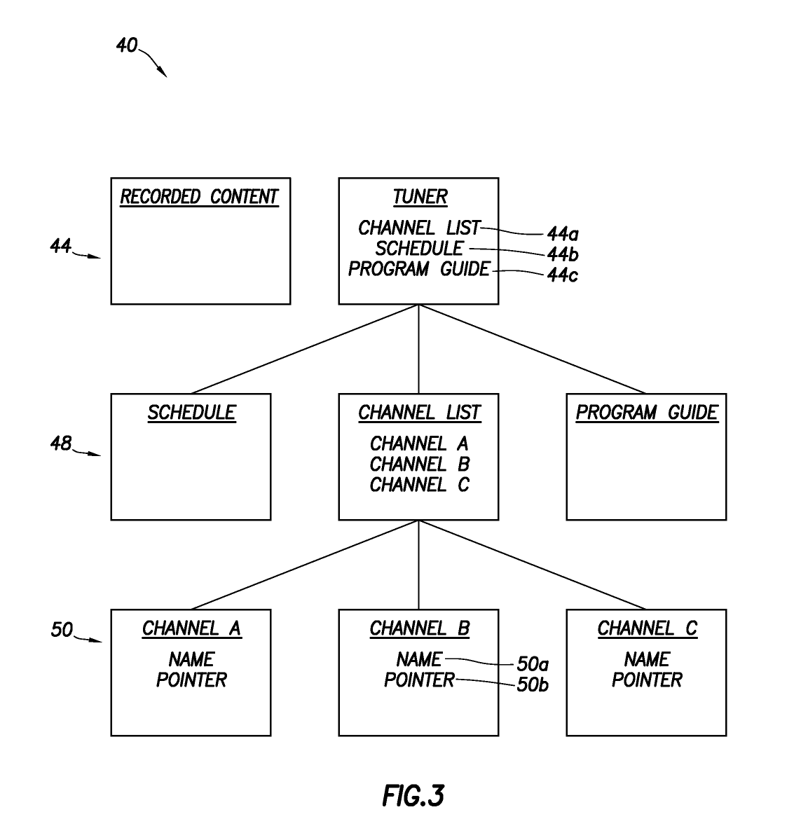

FIG. 2 shows an illustrative embodiment of computer 12. As shown in FIG. 2, computer 12 comprises a processor 20 coupled to a computer-readable medium (CRM) 22, a display 26, speaker 27, an input device 28, and a network interface 30. The computer-readable medium 22 comprises any suitable type of volatile memory (e.g., random access memory), non-volatile memory (e.g., hard disk drive, flash memory, read-only memory, compact disk read-only memory, etc.), or combinations thereof. The computer-readable medium 22 stores code 24 that is executable by processor 20. The computer-readable medium 22 may also be used to store local media content 25. In at least some embodiments, the processor 20, executing code 24, comprises logic that causes the computer 12 to perform some or all of the functionality described herein attributable to computer 12.

A user of the computer 12 interacts with the computer by using at least the input device 28 and display 26. In some embodiments, the input device 28 comprises a keyboard, mouse, track ball, or other type of pointing device. The computer 12 communicates with the content providers 14 via the network interface 30. Remote media content from the content providers 14 is received by the computer 12 via the network interface 30 and may be played on the computer 12 without storing the received media content in the computer-readable medium 22. In other embodiments, media content received over the network 25 is stored in the computer-readable medium 22 and played back from such storage medium on the computer 12. When media content is selected by the user, such content is played to the user via display 26 and/or speaker 27.

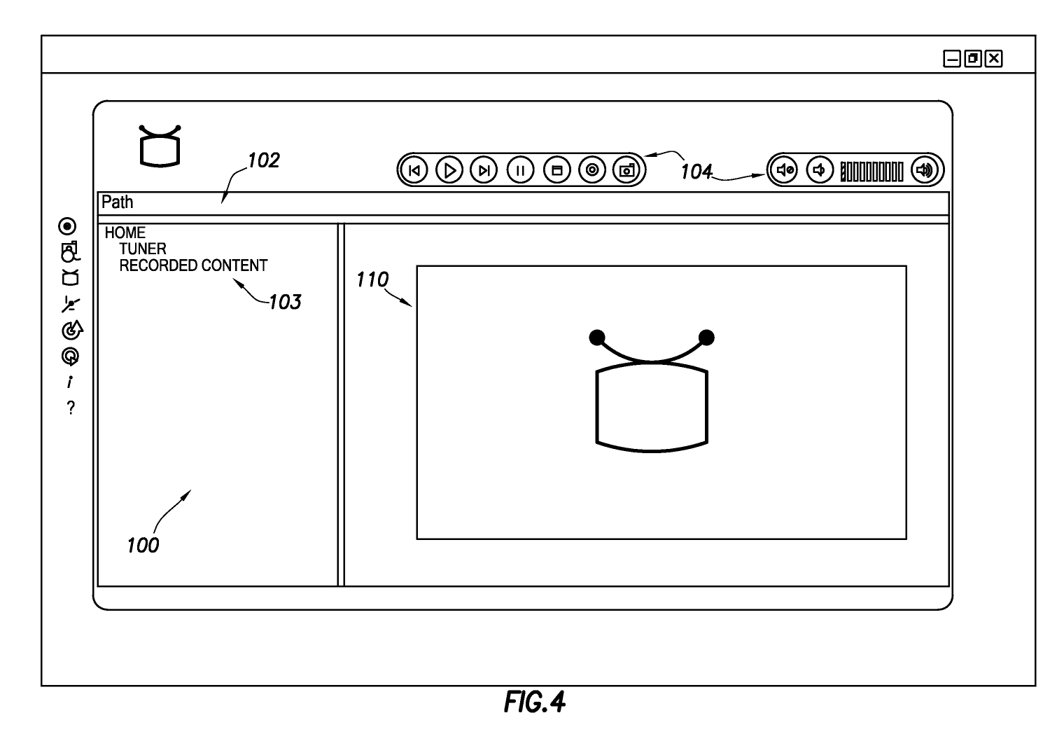

FIG. 3 shows an embodiment of metadata 40 pertaining to the media content. In at least some embodiments, the metadata comprises user-readable information characterizing the media content. An example of metadata comprises the name of the media content. For example, if the media content comprises a movie stored on the computer's computer-readable medium 22, the name may comprise the name of the movie. By way of an additional example, if the media content comprises a streamcast receivable from a content provider 14 over the network 25, the name may comprise the channel name associated with that particular streamcast. In some embodiments, the metadata information is encoded as folder (or directory) names on the computer's computer-readable medium 22 in which the local media content is stored. For example, a sub-folder may contain a particular movie having the name “X.” The name of sub-folder may also be “X” and, thus the metadata name “X” of the movie is encoded in the sub-folder name in which the underlying media content is stored. In some embodiments, folders/sub-folders on the computer's computer-readable medium 22 comprise pointers to remotely accessible media content. An example of a pointer comprises a uniform resource locator (URL), an internet protocol (IP) address, or other mechanism for accessing the remotely stored media content.

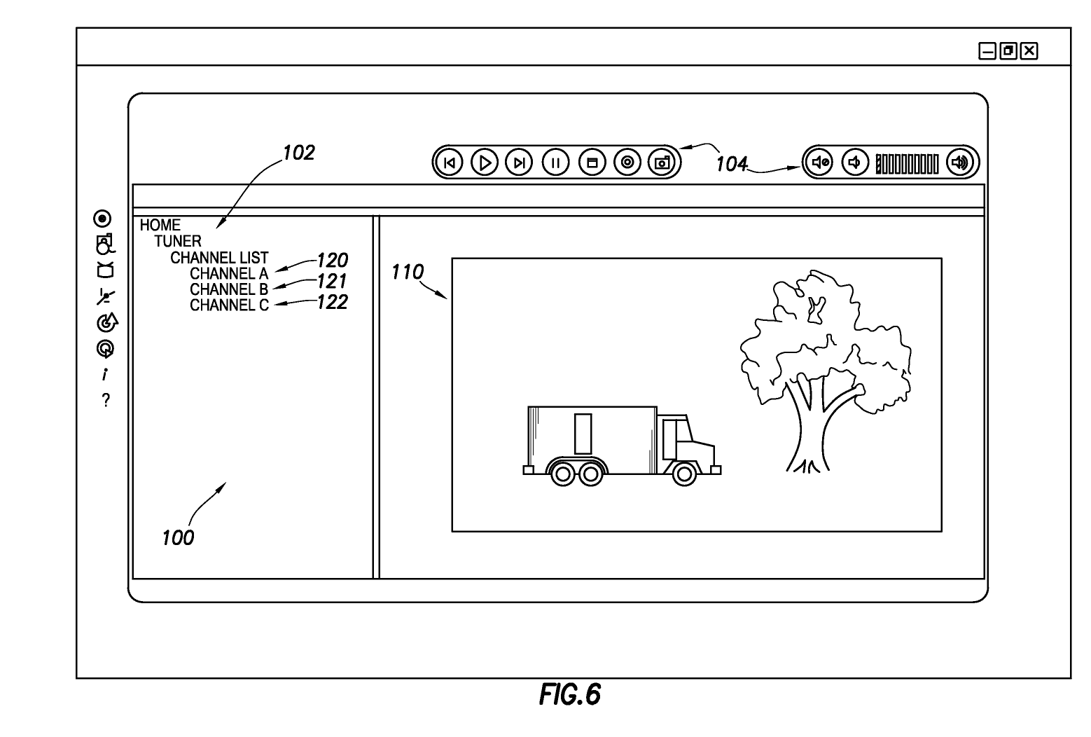

FIG. 3 provides an illustrative hierarchy by which the metadata 40 is organized. In some embodiments, the metadata 40 is organized in a parent-child relationship as shown in FIG. 3 and further illustrated in the examples of FIGS. 5-7. The particular hierarchy illustrated in FIG. 3 comprises multiple levels 44, 48, and 50. At the top level 44, the metadata comprises information about various types of media content. In the example of FIG. 3, top level 44 comprises “recorded content” and “tuner.” Recorded content comprises media content that has been previously recorded/downloaded and stored on the computer's computer-readable medium 22. The “tuner” metadata refers to one more types of “live” broadcasts (e.g., streamcasts) that the user can access. The term “tuner” is analogous to a television tuner in at least some embodiments. Such streamcasts can be accessed through, for example, a channel list 44a, a schedule 44b, and a program guide 44c. The channel list 44a comprises a list of user-accessible channels containing streamcasts. The schedule 44b comprises a mechanism by which a user can schedule broadcasts (e.g., multicasts) to be recorded and/or viewed later, while the program guide 44c comprises a list of viewable content from among one or more channels.

Hierarchy level 48 comprises information about one or more of the informational items within the “tuner” metadata. As shown in FIG. 3, hierarchy level 48 comprises information about the schedule 44b, channel list 44a, and program guide 44c identified in the tuner metadata in level 44. The channel list, for example, comprises identities of the various channels (e.g., channel A, channel B, channel C).

In the example of FIG. 3, hierarchy level 50 comprises information about one or more of channels A, B, and C of streamcasts associated with the channel list. Each channel A, B, C comprises a channel that is selectable by the user of computer 12 for playing on the computer 12. The metadata associated with each channel A, B, C comprises, for example, a name 50a and a pointer 50b. The name 50a of the channel comprises an alphanumeric name identifying that particular channel. The pointer 50b comprises the pointer (described above; e.g., IP address) that is used by computer 12 to access the streamcast associated with that particular channel.

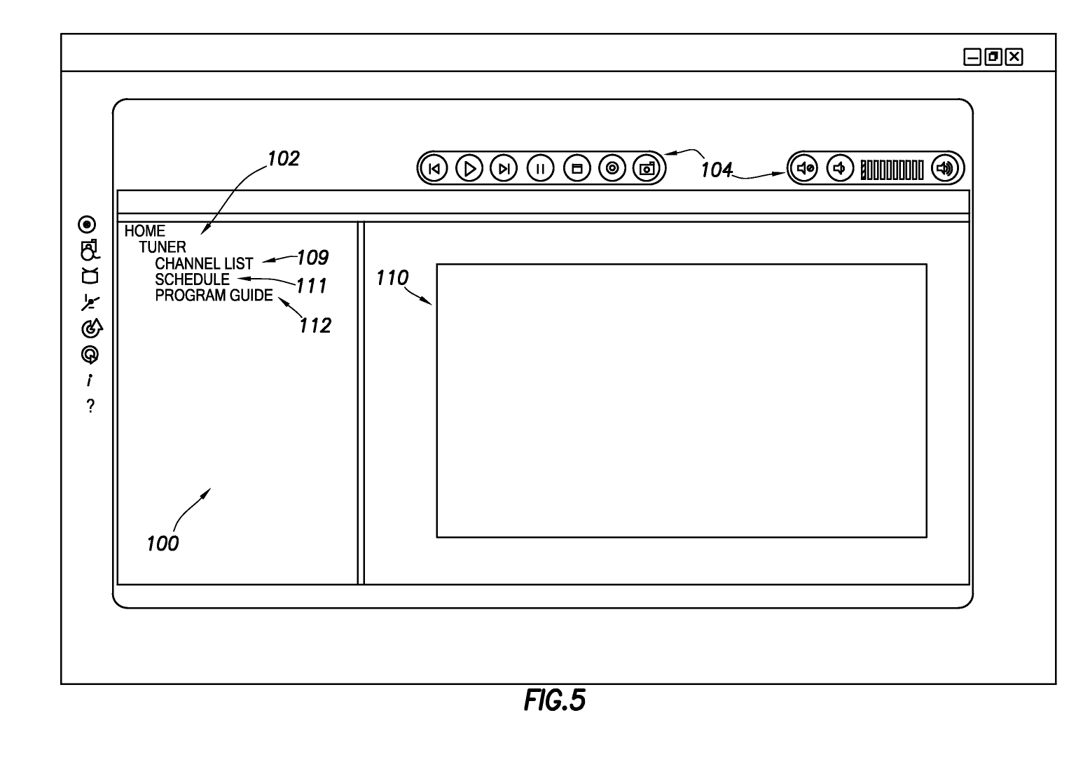

FIG. 4 shows a graphical user interface 100 comprising a user-navigatable source pane 102, playback controls 104, (e.g., Play, Pause, Volume, etc.), and a preview pane 110. The source pane 102 comprises one or more icons that are individually selectable by a user of computer 12 via input device 28. As used herein the term “icon” comprises any alphanumeric or graphical representation shown on display 26 that a user can select with input device 28. As show in FIG. 4, source pane 102 comprises, among other icons, “Tuner” and “Recorded Content” icons 103. Each of the Tuner and Recorded TV icons 103 are user-selectable.

FIG. 5 shows the source pane 102 upon the user selecting the Tuner icon 103. As shown in the example of FIG. 6, icons 109, 111, and 112 are shown associated with the channel list, schedule and program guide metadata as discussed above. Each of the icons 109, 111, and 112 also are user-selectable in accordance with at least some embodiments.

FIG. 6 illustrates the source pane 102 upon the user selecting the channel list icon 109. As shown in FIG. 6, the various channels (A, B, C) associated with the channel list are shown as icons 120, 121, and 122. When the user selects one of the channel icons 120-122, the streamcast associated with the selected channel begins to play in the preview pane 110. The streamcast plays even while the source pane continues to be shown on the graphical user interface 100. Thus, rather than being able to see only one of the source pane 102 and the preview pane 110 at a time, both panes 102 and 110 are simultaneously viewable to the user. As a result, while viewing a previously selected media content in the preview pane 110, a user can navigate through the source pane to select another media content or other media content related icons/metadata in the source pane 102. Upon another media content being selected in the source pane 102, the previously selected and currently playing media content automatically (i.e., without further user interaction) ceases playing, and the newly selected media content begins playing. While the examples of FIGS. 4-6 relate to the Tuner and Channel List metadata selections, the same process applies to the selection of other types of metadata. For example, the user could have selected the Recorded Content icon 103 in FIG. 4 which would have caused a list of pre-stored local media content to be shown in the source pane 102. The list of local media content may be organized by alphabetical order, by genre (user selected icons for different genres of movies such as action, comedy, drama, etc.) the selection of which causes the code 24 to then show a list of the local media content associated with the selected genre.

FIG. 7 provides a method 60 usable in conjunction with computer 12. In accordance with at least some embodiments, the method 60 is performed by code 24 executed on processor 20. At 62, a user of computer 12 causes the code 24 to show a list of media content (e.g., channel names, movie titles, etc.) in source pane 102 in the graphical user interface 100. At 64, a user selects an item of media content from the source pane 102. At 66, the code 24 plays the selected media content while continuing to show a list of media content in the source pane.

In accordance with at least some embodiments, the code 24 that performs one or more of the functions described herein comprises media player software. In other embodiments, the media player functionality of code 24 may be part of software that performs other functions in addition to the media player. For example, the functionality described herein attributed to code 24 may be a subset of the functions performed by an operating system that executes on computer 12.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A system, comprising:
a display;
logic coupled to said display, wherein said logic causes a source pane and a preview pane to be shown on said display, said source pane identifying sources of media content to be viewed in said preview pane, said preview pane playing a selected media content while said source pane is still viewable.

2. The system of claim 1 wherein said sources of media content comprise media content stored on said system as well as media content accessible to said system from a location on a network.

3. The system of claim 1 wherein said logic causes said media content to be organized in said source pane in a parent-child arrangement.

4. The system of claim 1 wherein the preview pane and said source pane are part of a media player graphical user interface.

5. The system of claim 1 wherein, while a previously selected media content is playing in said preview pane, said logic enables a user to navigate the source pane.

6. The system of claim 1 wherein, while a previously selected media content is playing in said preview pane, said logic enables a user to select another media content in the source pane.

7. The system of claim 6 wherein said logic ceases playing said previously selected media content and begins playing said another media content in said preview pane.

8. The system of claim 1 wherein said media content comprises any of a group consisting of audio, video, and combinations thereof.

9. A computer-readable medium (CRM) comprising software that, when executed by a processor, causes the processor to:
show a source pane and a preview pane on a display; and
in the preview pane, play media content selected by a user in the source pane;
wherein said source pane continues to be shown while said media content is playing in the preview pane.

10. The CRM of claim 9 wherein said software also causes the processor to enable a user to select, while previously selected media content is playing in the preview pane, another media content from the source pane to play in the preview pane.

11. The CRM of claim 10 wherein said software also causes the processor to cease playing said previously selected media content and begin playing said another media content in the preview pane

12. The CRM of claim 9 wherein said software causes said processor to list media content in the source pane, said list of media content comprising media content stored on a system containing said CRM as well as media content accessible to said system from a location on a network.

13. The CRM of claim 9 wherein said software causes the processor organize said media content in the source pane in a parent-child arrangement.

14. A method, comprising:
showing a list of user-selectable media content in a source pane; and
playing one of said media content in a preview pane while continuing to show said list in the source pane.

15. The method of claim 14 wherein showing the list comprises showing a list of media content in a parent-child relationship.

16. The method of claim 14 wherein showing the list comprises listing at least one media content stored locally and at least one media content accessible over a network.

17. The method of claim 16 further comprising ceasing playing said one of said media content as a result of a user selecting a different one of said media content in said source pane.

18. The method of claim 14 further comprising ceasing playing said one of said media content as a result of a user selecting a different one of said media content in said source pane.
